(19) United States
(12) Patent Application Publication
(10) Pub. No.: US 2010/0011918 A1
(43) Pub. Date: Jan. 21, 2010

(54) Screwdriver bit with magnetic collar

(76) Inventor: Josh Ray, (US)

Correspondence Address: Erik V. Chmelar, 3348 E. Ryan Drive, Midland, MI, 48642, US

(21) Appl. No.: 12/218,561

(22) Filed: Jul. 17, 2008

(51) Int. Cl. B25B 23/08

(52) U.S. Cl. 81/451

(57) ABSTRACT

A one-piece screwdriver bit comprising a large diameter shank defined on a first end adapted to communicate with a power screwdriver, a driver tip defined on a second end adapted to communicate with a recessed drive portion within a screw head, a small-diameter neck between the shank and driver tip, and a ring magnet permanently affixed about the neck proximal to the driver tip, wherein a gap exists between the ring magnet and a screw head when the driver tip is engaged to a recessed drive portion within a screw head.

### BACKGROUND OF THE INVENTION

The present invention relates generally to an improved screwdriver bit that secures a screw on the end of the bit by means of a magnetic collar, wherein the screw can be easily driven into an object without having to hold or stabilize such screw, especially during the initial driving of such screw.

When starting to drive a screw, it may be necessary to stabilize such screw to prevent the screwdriver bit from slipping or to prevent the screw from wandering. Although pre-drilling a pilot hole may help stabilize such screw, this is often times not practical. Therefore, common practice is simply to hold such screw with one's fingers. However, as the screw rotates, the threads can cut into the skin and cause injury. Furthermore, it may be impractical or impossible to hold and drive a very short screw, such as typical self-tapping sheet metal screws used in steel-frame construction.

There are several prior art solutions to the above-described problem. The fastener itself can be held by an external device while driving, as taught in U.S. Pat. No. 6,925,909 B2 (Crosby, et. al.) and U.S. Pat. No. 4,843,923 (Voss). Alternatively, a driver bit itself can be modified to include a collar or sleeve that encompasses the screw head, as taught in U.S. Pat. No. 4,581,962 (Marbourg), U.S. Pat. No. 4,736,658 (Jore), and U.S. Pat. No. 4,862,774 (Else, et. al.). A driver bit can also be modified to include one or more magnets mounted at or near the driver tip, as is taught in U.S. Pat. No. 7,204,177 B1 (Garner, et. al.), U.S. Pat. No. 2,782,822 (Clark), U.S. Pat. No. 5,724,873 (Hillinger), and U.S. Pat. No. 6,209,426 B1 (Takahashi).

U.S. Pat. No. 6,209,426 B1 (Takahashi) teaches a driver bit assembly, for use with robotic arms, with a replaceable ring spacer sandwiched between two ring magnets mounted about a cylindrical portion of the driver shaft proximal to the driver tip. The magnets and spacer are specifically attached to the driver bit by magnetic force alone, such that when fatigue and failure of the driver tip occurs, the ring magnets and spacer can be easily detached. The present invention teaches a similar driver bit; however, several key differences exist. First, because the driver bit of the present invention is targeted for steel framing sheet metal screws, the magnetic attractive force between the steel framing and a removable ring magnet could easily overcome the magnetic attractive force of the removable ring magnet to the driver bit itself, causing the removable ring magnet to slide off the driver bit and be lost. Thus, the present invention teaches a driver bit in which a single ring magnet is permanently affixed about a cylindrical portion of the driver shaft proximal to the driver tip, thereby overcoming this limitation of the prior art. Additionally, the driver bit of a driver used for sheet metal framing takes a significant amount of abuse and eventually wears out, requiring frequent replacement. The simple, one-piece construction of the driver bit of the present invention enables the bit to be manufactured inexpensively, enabling construction workers to economically replace the entire driver bit when it wears out rather than keeping track of replacement driver bit shafts, ring magnets, and spacers.

Accordingly, what is desired, and has not heretofore been developed, is a one-piece screwdriver bit that secures a screw on the end of the bit by means of a single ring magnet that is permanently affixed about a cylindrical portion proximal to the driver tip.

### BRIEF SUMMARY OF THE INVENTION

It is an object of the present invention to provide a screwdriver bit with a magnetic collar permanently affixed near the driver end of such screwdriver bit to secure the head of a screw on the end of such bit.

It is an object of the present invention that the protruding driver end of the screwdriver bit communicate directly with the recessed driver portion of a screw, leaving a gap between the magnetic collar and the head of such screw.

It is an object of the present invention that the protruding driver end of the screwdriver bit may be any type of drive, such as slotted, cross-head, Phillips, hex, or torx.

It is an object of the present invention that the magnetic collar be a one-piece ring magnet permanently mounted about the cylindrical portion proximal to the driver tip.

It is an object of the present invention to provide a screwdriver bit that is simple and inexpensive to manufacture.

### BRIEF DESCRIPTION OF THE DRAWINGS

FIG. 1 is a perspective view of the screwdriver bit and magnetic collar.

FIG. 2a, FIG. 2b, and FIG. 2c are perspective, side, and front views of the screwdriver bit and magnetic collar assembly.

FIG. 3a and FIG. 3b are perspective and side views of the screwdriver bit and magnetic collar assembly with driver tip engaged to the head of a screw, showing the gap that exists between the magnetic collar and the screw head.

### DETAILED DESCRIPTION OF THE INVENTION

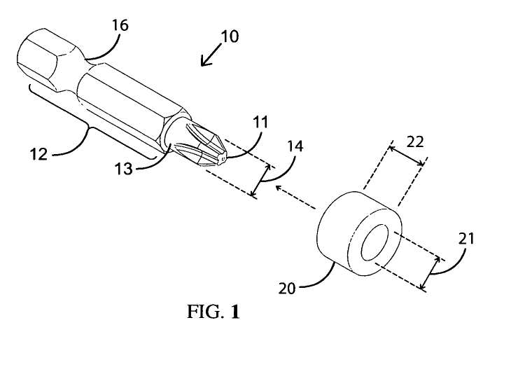

FIG. 1 shows how the magnetic collar 20, with magnetic collar inner diameter 21 and magnetic collar length 22, is inserted about the driver bit neck 13 of the bit 10, adjacent to the driver bit shank 12 and proximal to the driver bit tip 11. The magnetic collar inner diameter 21 is slightly larger than the driver bit neck outer diameter 14, such that the magnetic collar 20 may be glued with any of a number of commercially available adhesives or otherwise permanently affixed about the driver bit neck 13. Because a preferable material choice for the magnetic collar 20 is a rare earth ring magnet, press fitting such fragile ring magnet about the driver bit neck 13 is not advisable since it could weaken, crack, or break such ring magnet.

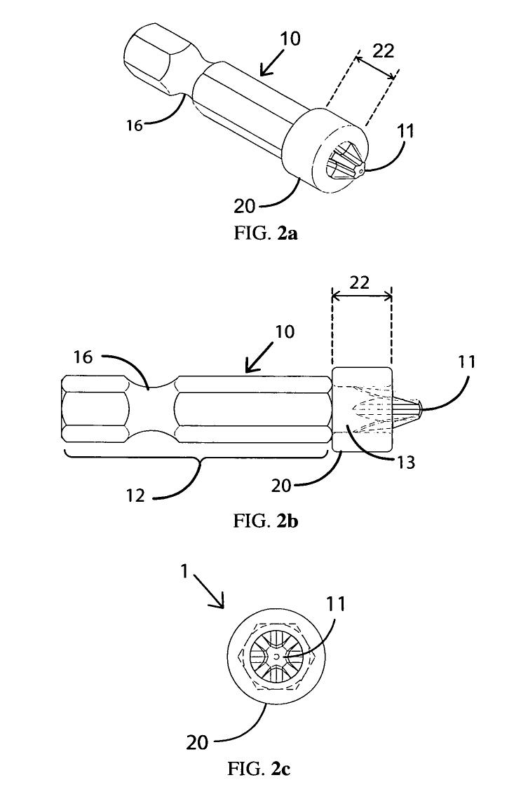

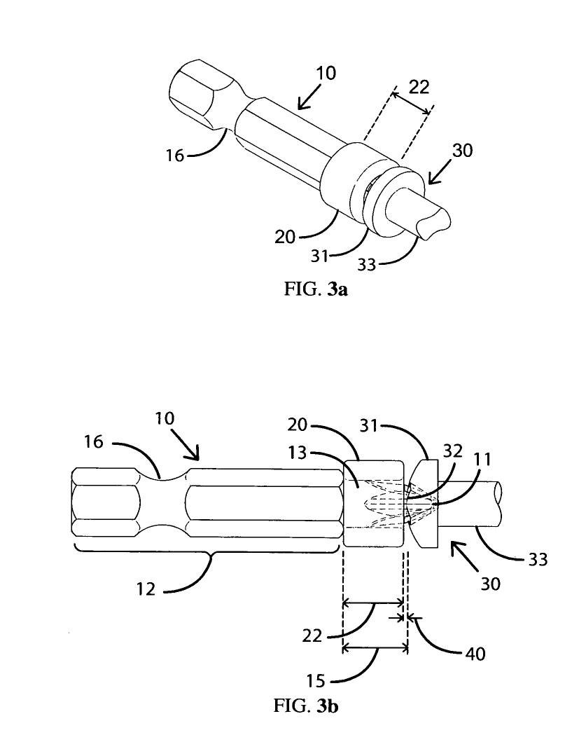

As shown in FIG. 2a and FIG. 2b, the driver bit tip 11 extends distally from the magnetic collar 20, able to appropriately engage the screw drive 32 within the screw head 31 of a screw 30 as shown in FIG. 3a and FIG. 3b. The magnetic collar length 22 is configured such that a gap 40 exists between the magnetic collar 20 and the screw head 31, which both protects the magnetic collar 20 from damage and stabilizes the screw 30 along the longitudinal axis of the bit 10.

The bit 10 defines a driver bit shank 12 on the end opposite the driver bit tip 11 for engaging a socket of a hand or power screwdriver or the or chuck of a power drill. Heretofore the term “power screwdriver” is used to describe any tool with a recessed portion, such as a socket or chuck, that is capable of engaging the bit 10. The exemplary driver bit shank 12 is shown in the figures as defining the commercially standard hexagonal power drive shank for communication with a power screwdriver. Furthermore, the exemplary driver bit shank 12 includes an annular driver bit shank depression 16 for communicating with a locking mechanism, such as a detente ball, c-clip, or spring, within the socket of a power screwdriver. Although this is the preferred configuration of the bit 10, the driver bit shank 12 may define any suitable configuration, with or without the driver bit shank depression 16, for communicating with a power screwdriver.

What is claimed is:

1. A screwdriver bit including a first end, a middle portion, and a second end, said screwdriver bit comprising:
a shank defined on said first end,
said shank defining an outer diameter, and
said shank adapted to communicate with the socket of a power screwdriver;
a neck defined on said middle portion,
said neck defining an outer diameter smaller than said outer diameter of said shank, and
said neck defining a length;
a driver tip defined on said second end, said driver tip adapted to communicate with a recessed drive portion within a screw head; and
a magnetic collar permanently affixed about said neck adjacent to said shank,
said magnetic collar defining an inner diameter slightly larger than said outer diameter of said neck, and
said magnetic collar defining a length slightly shorter than said length of said neck;
wherein said magnetic collar and said screw head define a gap therebetween when said driver tip communicates with said recessed drive portion of said screw head.

2. The screwdriver bit of claim 1 wherein said magnetic collar is affixed to said neck by a permanent adhesive.

3. The screwdriver bit of claim 1 wherein an annular depression is defined about said shank for communicating with a locking mechanism within the socket of a power screwdriver.

4. A screwdriver bit including a first end, a middle portion, and a second end, said screwdriver bit comprising:
a shank defined on said first end,
said shank defining an outer diameter, and
said shank adapted to communicate with the socket of a power screwdriver;
a neck defined on said middle portion,
said neck defining an outer diameter smaller than said outer diameter of said shank, and
said neck defining a length;
a driver tip defined on said second end, said driver tip adapted to communicate with a recessed drive portion within a screw head; and
a magnetic collar affixed by permanent adhesive about said neck adjacent to said shank,
said magnetic collar defining an inner diameter slightly larger than said outer diameter of said neck, and
said magnetic collar defining a length slightly shorter than said length of said neck;
wherein said magnetic collar and said screw head define a gap therebetween when said driver tip communicates with said recessed drive portion of said screw head.

5. The screwdriver bit of claim 4 wherein an annular depression is defined about said shank for communicating with a locking mechanism within a power screwdriver.

6. A screwdriver bit including a first end, a middle portion, and a second end, said screwdriver bit comprising:
a shank defined on said first end,
said shank defining an outer diameter,
said shank adapted to communicate with the socket of a power screwdriver, and
said shank including an annular depression for communicating with a locking mechanism within a power screwdriver;
a neck defined on said middle portion,
said neck defining an outer diameter smaller than said outer diameter of said shank, and
said neck defining a length;
a driver tip defined on said second end, said driver tip adapted to communicate with a recessed drive portion within a screw head; and
a magnetic collar permanently affixed about said neck adjacent to said shank,
said magnetic collar defining an inner diameter slightly larger than said outer diameter of said neck, and
said magnetic collar defining a length slightly shorter than said length of said neck;
wherein said magnetic collar and said screw head define a gap therebetween when said driver tip communicates with said recessed drive portion of said screw head.
